(19) United States
(12) Patent Application Publication
(10) Pub. No.: US 2009/0040052 A1
(43) Pub. Date: Feb. 12, 2009

(54) Assistance alert method and device

(76) Inventors: Jeffry Michael Cameron, McKinney, TX (US); Susan Catherine Cameron, McKinney, TX (US); Michael Gallucci Cameron, McKinney, TX (US)

Correspondence Address: Michael Cameron, 2025 Savannah Drive, McKinney, TX, 75070, US

(21) Appl. No.: 12/221,387

(22) Filed: Aug. 2, 2008

Related U.S. Application Data
(60) Provisional application No. 60/963,355, filed on Aug. 6, 2007.

(51) Int. Cl. G08B 23/00

(52) U.S. Cl. 340/573.1

(57) ABSTRACT

Methods and devices used to alert others of the health and welfare of a person. The present invention uses at least one sensor, such as a motion sensor or accelerometer, a clock, a timer, an audible alarm, at least one button with multiple functionality or several buttons each having a specific functionality, and a transmitter adapted to send health and welfare data across at least one communication channel to a receiver. The present invention can further include a location based sensor adapted to allow a person to find the user. The device of the present invention uses one set of functions which allows the user to confirm to another that the user is well, and another set of functions that determine that a user may be unconscious or incapacitated and hence notify another of such fact.

### CROSS-REFERENCE TO RELATED APPLICATIONS

This application claims the benefit of U.S. Provisional Application No. 60/963,355 filed on Aug. 6 2007, entitled “Assistance Alert Method and Device.”

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

There exists conventional medical alert devices which are made available to the elderly and infirm. The user is required to press a help button that can be worn as a neck pendant, wristwatch or module having a belt clip attachment. Once the help button is pushed, a medical alarm console or telephone is activated. The user is then connected to a monitoring station. A dispatcher at the monitoring station or at the number that is called communicates with the user through the console. The dipatcher assesses the situation and obtains assistance for the user, such as by calling an ambulance. As can be seen, such conventional medical alert devices require that the user be conscious and be able to press a help button at which time help is dispatched. Such conventional medical alert device do not help if patient is unconscious or otherwise incapacitated.

It would be advantageous to have a system and method for providing help to a person, such as someone who is elderly, infirm, has a medical condition, or otherwise may become isolated, in the event the person becomes unconscious or incapacitated such that they are unable to activate a conventional medical alert system. The present invention provides such a system and method.

### BRIEF SUMMARY OF THE INVENTION

The present invention relates to methods and devices used to alert others of the health and welfare of a person, such as a person who is elderly, infirm, has a medical condition, or who otherwise may become isolated.

The present invention uses at least one sensor, such as a motion sensor or accelerometer, a clock, a timer, an audible alarm, at least one button with multiple functionality or several buttons each having a specific functionality, and a transmitter adapted to send health and welfare data across at least one communication channel to a receiver. The present invention can further include a location based sensor adapted to allow a person to find the user.

The device of the present invention uses one set of functions which allows the user to confirm to another that the user is well, and another set of functions that determine that a user may be unconscious or incapacitated and hence notify another of such fact.

### BRIEF DESCRIPTION OF THE SEVERAL VIEWS OF THE DRAWING

In the following section, the invention will be described with reference to exemplary embodiments illustrated in the figures, in which:

FIG. 1 is a flow chart of the method of a first embodiment of the present invention;

FIG. 2 is a block diagram of the device of a first embodiment of the present invention;

FIG. 3 is a flow chart of the method of a second embodiment of the present invention;

FIG. 4 is a block diagram of the device of a second embodiment of the present invention;

FIG. 5 is a flow chart of the method of a third embodiment of the present invention;

FIG. 6 is a block diagram of the device of a third embodiment of the present invention;

FIG. 7 is a flow chart of the method of a fourth embodiment of the present invention;

FIG. 8 is a block diagram of the device of a fourth embodiment of the present invention;

FIG. 9 is a flow chart of the method of a fifth embodiment of the present invention;

FIG. 10 is a flow chart of the method of a sixth embodiment of the present invention;

FIG. 11 is a block diagram of the device of a sixth embodiment of the present invention;

FIG. 12 is a flow chart of the method of a seventh embodiment of the present invention;

FIG. 13 is a block diagram of the device of a seventh embodiment of the present invention.

### DETAILED DESCRIPTION

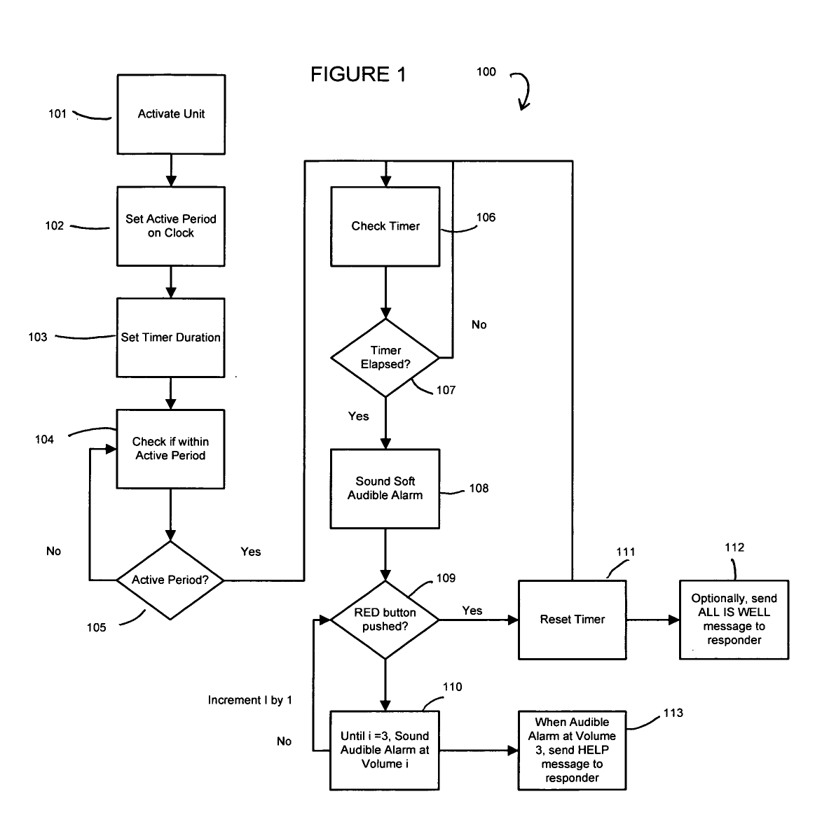

FIG. 1 is a flow chart of the method 100 of the first embodiment of the present invention. The first embodiment of the present invention is adapted to activate a timer having a set duration, e.g., 2 hours. Once the timer has elapsed, then an audible alarm on the device sounds, alerting the user to press a flashing RED button. Once pushed, the device can be adapted to send a message, e.g., ALL'S WELL over a communications channel to a receiver at which the message is received by, e.g., caregiver, first responder, relative, dispatch center, or the like.

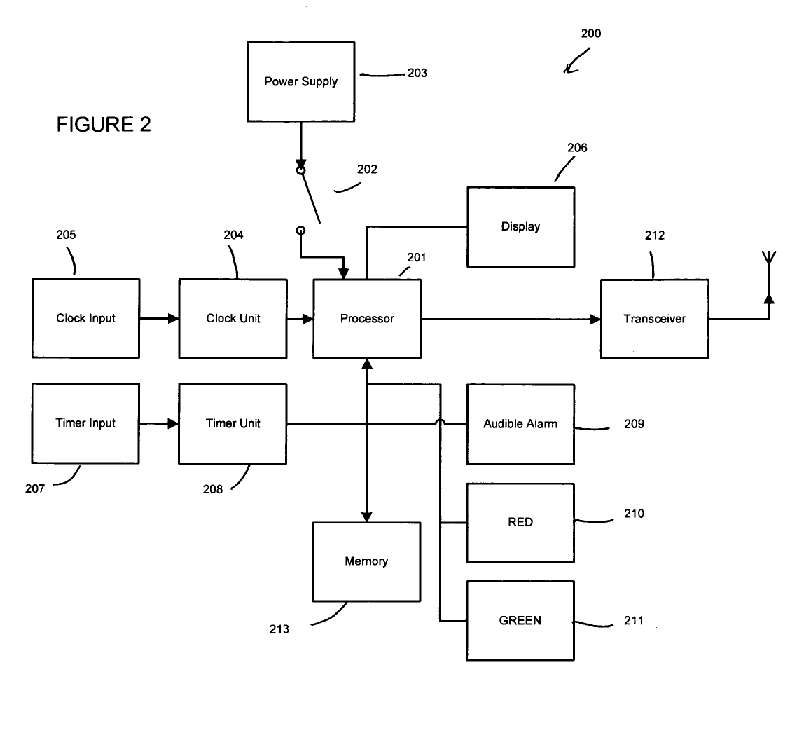

As seen therein, in step 101, the device of the present invention is (described in FIG. 2) is activated. In step 102, the period during which the device will be active can be set using, for example, a clock. The device can have a screen, such as an LED or LCD screen, which allows the user to set the active period. For example, the user could set the device so that the active period is from 6:00 a.m. to 10:00 p.m. By default, the device is then inactive during the period from 10:00 p.m. to 6:00 a.m., for example, during the period the user may be asleep. In step 103, the duration of a timer on the device is set. Alternatively, the device can have a semi-active period during which the timer is set for a longer or shorter period.

In steps 104 and 105, a check is made from time to time of whether the device is within the active period. If so, then in steps 106/107, the timer is checked from time to time. If the timer has elapsed, then, in step 108, the audible alarm is sounded at a threshold level audible to human hearing, the level of which can be set by the user. For purposes hereof, the volume at that level is referred to as level i=0. In step 109, a separate alarm sub timer is initialized. A check is then made in step 110 of whether the RED button has been pressed. If the RED button has not been pushed within a preset period as determined by the alarm sub timer in steps 111/112, then the volume, i, is incremented by 1 in step 113. After the volume is incremented, the sub timer is initialized again pursuant to step 109, and a check is again made as to whether the RED button is pressed in step 110. If, during the process of checking if the RED button is pressed, the answer is YES, then the timer is reset in step 115, and optionally, in step 116, an ALL'S WELL is sent over communication channel to, e.g., a caregiver, first responder, relative, dispatch center, or the like, which can be sent by pressing, e.g., the GREEN button. If the RED button is not pushed by the time the volume has increased to a volume level of i=3, then, inasmuch as the user may be incapacitated or unconscious, in step 117, a mandatory HELP message is sent over the communications channel to a caregiver, first responder, relative, dispatch center, or the like.

The caregiver, first responder, relative, dispatch center, or the like, may then try to call the user over a telephone. If the user answers the telephone such that help is not needed, then the RED button can be pushed to reset the timer, as in step 109, or alternatively, the person who called the user may be able to enter a code or tones which are received by the unit and cause it to be reset. The device can be adapted to communicate the HELP and ALL'S WELL messages in any number of ways: (1) over a short range wireless link to a base station, handset or mobile terminal, that then can access (a) the public telephone network and send the message as a computer generated voice, (b) the wireless network and send the message as (i) a computer generated voice, (ii) SMS text message, or (iii) a multimedia message; or (2) directly to the wireless telecommunications network, e.g., WiMax, CMDA, GSM, WCDMA, HSPA, UMTS, 3G, 4G, and send the message as (1) a computer generated voice, (2) and SMS text message, or (3) a multimedia message. When using a short range wireless link, said link can be e.g., a WiFi link, Bluetooth link or the like. For example, the device can be a Bluetooth enabled device worn by a user that is coupled over a first wireless interface to a handset and then cause the handset to communicate over a second wireless interface over the wireless communications system.

FIG. 2 is a block diagram of the device 200 of a first embodiment of the present invention. As seen therein, the device 200 of the present invention comprises several functional blocks coupled via data busses and adapted to perform the method described in FIG. 1. The processor block 201, being the main functional element is activated using e.g., an on-off switch 202, coupled to power block 203, which is also adapted to provide regulated power to other parts of the device 200 via a power bus (not shown). The device has a clock unit 204, which is set to the time at the location of the user. Signals, as determined from user input from user input block 205, derived from clock unit 204 can be used to determine when the processor 201 is in its active state.

The device 200 includes as display 206, such as an LED or LCD screen, which allows the user to see what parameters have been set via the various input units. The device further includes a timer unit 207 and a timer input 208 where the duration of the timer unit 207 on the device 200 is set. Once set, the timer unit 207 counts down to zero (or alternatively, to a certain number of hours/minutes/seconds). Once the timer unit 207 has elapsed, then an audible alarm 209 sounds, alerting the user to press a flashing RED button 210. Once pushed, the device 200 can be adapted to send, either automatically, or by pressing GREEN button 211, a message, e.g., ALL'S WELL over a communications channel from transceiver 212 to a receiver 214 at which the message is received by, e.g., a caregiver, first responder, relative, dispatch center, or the like. The caregiver, first responder, relative, dispatch center, or the like, may then try to call the user over a telephone. If the user answers the telephone such that help is not needed, then RED button 210 can be pushed to reset timer in timer unit 208, or alternatively, the person who called the user in response to receiving the HELP message, may be able to enter a code or tones into their handset, e.g., causing their handset to send certain predetermined DTMF tones which, when received by transceiver 212, cause the timer of timer unit 208 to be reset. The device 200 can be in a form factor of a neck pendant, wristwatch or module having a belt clip attachment.

The transceiver 212 can utilize any number of communication channels, such as: (1) over a short range wireless link to a base station, that then can access (a) the public telephone network and send the message as a computer generated voice, (b) a wireless network and send the message as (i) a computer generated voice, (ii) and SMS text message, or (iii) a multimedia message; or (2) directly to a wireless telecommunications network, e.g., WiMax, CMDA, GSM, WCDM, 3G, 4G, and send the message as (1) a computer generated voice, (2) and SMS text message, or (3) a multimedia message. When using a short range wireless link, said link can be e.g., a WiFi link, Bluetooth link or the like. The memory 213 would store messages in an appropriate format that can be decoded as text messages, audible messages, multimedia messages, etc., and that are sent to the transceiver 212 to be modulated and sent over the communications channel to a receiver 214 to be received by a caregiver, first responder, relative, dispatch center, or the like. When using a short range wireless link, said link can be e.g., a WiFi link, Bluetooth link or the like. For example, the device 200 can be a Bluetooth enabled device worn by a user that is coupled over a first wireless interface to a transceiver 214 in the form of a handset and then cause the handset to communicate over a second wireless interface over the wireless communications system. Alternatively, the device 200 can be integrated into the form factor of a handset or mobile terminal.

Processor 201 is adapted to be able to determine, based on the clock unit 204, whether the device 200 is within the active period. If so, then the processor 201 is adapted to check to see of the timer of timer unit 208 has elapsed, from time to time. Timer unit can further be adapted to serve as the alarm sub timer unit needed to determine the amount of time that has elapsed since the volume of the audible alarm 209 has incremented. If the timer has elapsed, then the processor 201 is adapted to sound audible alarm 209 at a threshold level audible to human hearing, the level of which can be set by the user. The processor, with reference to the alarm sub timer, is then adapted to check if the RED button 210 has been pressed. If the processor determines, based on signals from the alarm sub timer, that the RED button 210 has not been pushed within a certain time period, then the processor 201 causes the volume of audible alarm 209 to be incremented (up to a certain number of times). Each time the volume is incremented, the processor 201 checks again as to whether the RED button 210 has been pressed. If, during the process of checking if the RED button 210 has been pressed, the processor 201 determines that the answer is YES, then the timer of timer unit 208 is reset, and optionally, an ALL'S WELL message, in any format or language or verbiage, is fetched, either automatically or upon the pressing of GREEN button 211, from memory 213, transferred to transceiver 212, modulated and sent over a communication channel to a receiver. If the RED button 210 is not pushed by the time the volume has increased to a certain, predetermined volume level, then, inasmuch as the user may be incapacitated or unconscious, the processor 201, a mandatory HELP message in any format or language or verbiage, is fetched from memory 213, transferred to transceiver 212, modulated and sent over a communication channel to a receiver. A caregiver, first responder, relative, dispatch center, or the like, may then try to call the user over a telephone. If the user answers the telephone such that help is not needed, then the GREEN button 211 can be pushed to reset the timer of timer unit 208. A further element to this embodiment includes the ability to put the unit in a temporary idle mode (for a certain period of time, e.g., 15 minutes) by pressing, e.g., the RED button 210 and GREEN button 211 at the same time momentarily.

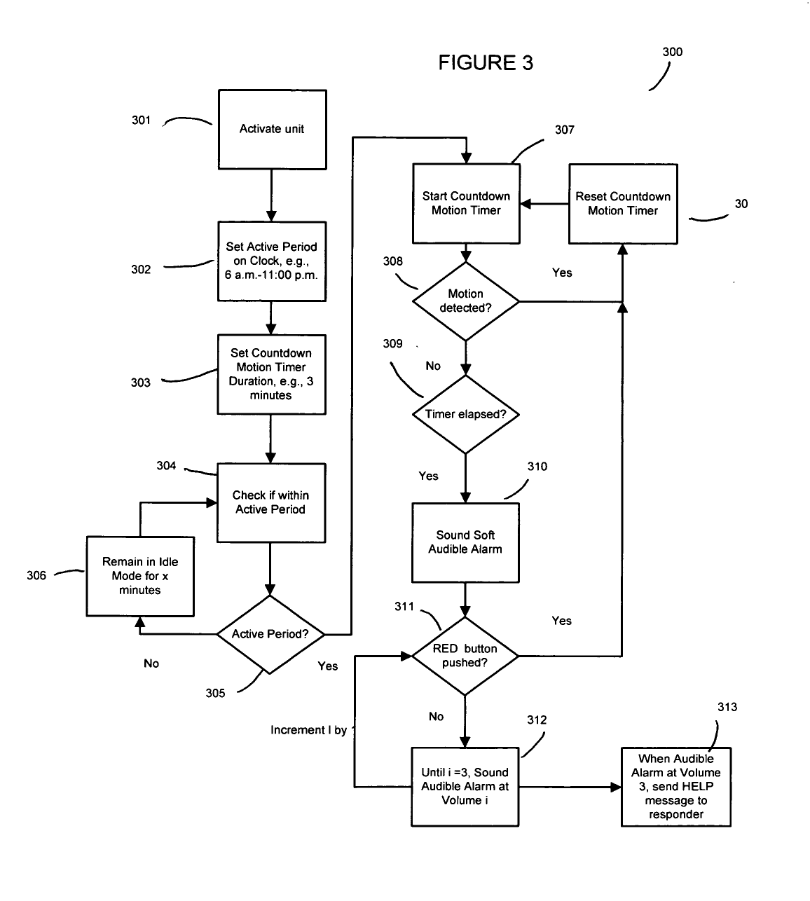

FIG. 3 is a flow chart of the method 300 of the second embodiment of the present invention. As seen therein, in step 301, the device of the present invention is activated. In step 302, the period during which the device will be active can be set using, for example, a clock. The device can have a screen, such as an LED or LCD screen, which allows the user to set the active period. In step 303, the duration of a countdown motion timer on the device is set. The second embodiment of the present invention is adapted to reset a timer having a set duration, e.g., 2 minutes, each time it detects or senses motion. If the timer elapses without the motion detector sensing or detecting any motion, then an audible alarm on the device sounds, alerting the user to press a button, e.g., a flashing RED button. Once pushed, the timer is reset. If the button is not pressed within a second time period, e.g., 30 seconds, then a HELP message is sent to another person, e.g., relative, responder or dispatch center over a communication channel as described with respect to the first embodiment of the present invention. In steps 304 and 305, a check is made from time to time of whether the device is within the active period. If not, in step 306 the device remains in idle mode and checks from time to time, whether it has entered active mode. If so, then in steps 307, a countdown timer is checked from time to time. If motion is detected then the countdown timer is reset in step 310. Based on the foregoing, if the timer has elapsed, then necessarily, no motion has been detected and hence, in step 311, an audible alarm is sounded at an initial threshold level audible to human hearing, the level of which can be set by the user. For purposes hereof, the initial volume is referred to as level i=0. If the RED button has not been pushed within a preset period as determined by the alarm sub timer in steps 312, 313, 314 and 315, then the volume, i, is incremented by 1 in step 316. After the volume is incremented, the sub timer is initialized again pursuant to step 312, and a check is again made as to whether the RED button is pressed in step 313.

If, during the process of checking if the RED button is pressed, the answer is logic 1, YES or TRUE, then the countdown timer is reset in step 310. If the RED button is not pushed by the time the volume has increased to a volume level of i=3, then, inasmuch as the user may be incapacitated or unconscious, in step 318, a mandatory HELP message is sent over the communications channel to a caregiver, first responder, relative, dispatch center, or the like. The caregiver, first responder, relative, dispatch center, or the like may then try to call the user over a telephone. If the user answers the telephone such that help is not needed, then the RED button can be pushed to reset the timer, as in step 310, or alternatively, the person who called the user may be able to enter a code or tones which are received by the unit and cause it to be reset.

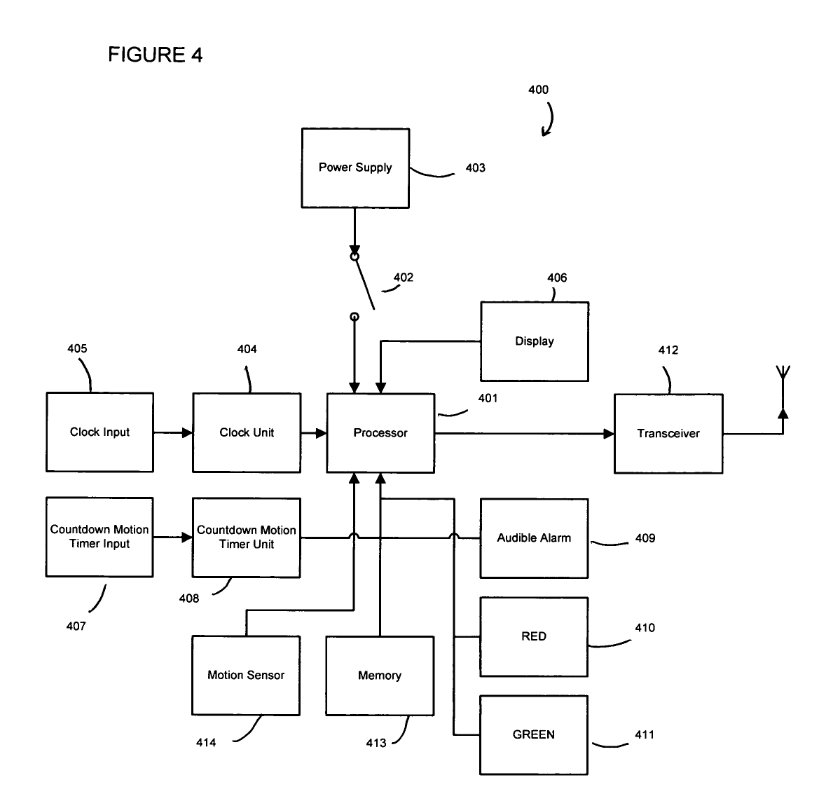

FIG. 4 is a block diagram of the device 400 of a second embodiment of the present invention. As seen therein, the device 400 of the present invention comprises several functional blocks coupled via data busses and adapted to perform the method described in FIG. 3. The processor block 401, being the main functional element, is activated using e.g., an on-off switch 402 coupled to power block 403, which is also adapted to provide regulated power to other parts of the device 400 via a power bus (not shown). The device has a clock unit 404, which is set to the time at the location of the user. Signals, as determined from user input from user input block 405, derived from clock unit 404 can be used to determine when the processor 401 is in its active state.

The device 400 includes as display 406, such as an LED or LCD screen, which allows the user to see what parameters have been set via the various input units. The device further includes a countdown motion timer unit 408 and a countdown motion timer input 407 allowing the duration of the countdown timer on the device 400 to be set. The countdown timer is used to determine whether a certain amount of time has elapsed since the motion sensor 414 has sensed motion. Countdown motion timer unit 408 is further adapted to serve as an alarm sub timer adapted to determine when volume of audible alarm 409 is to be incremented.

A check is made from time to time of whether the device 400 is within the active period. If not, the device 400 remains in idle mode and continues to check, from time to time, whether it has entered active mode. If it determines it is in active mode, then the countdown motion timer unit 407 is checked from time to time. Each time motion is detected by motion sensor 414, the timer in countdown motion timer unit 408 is reset, and the timer begins counting down again. Based on the foregoing, if the countdown motion timer elapses, then necessarily, no motion has been detected by motion sensor 414 during the time selected. Once the timer has elapsed then the audible alarm 409 is sounded at an initial, threshold level audible to human hearing, the level of which can be set by the user. In addition, the device can strobe a high intensity strobe (not shown) to alert the user. The activation of the audible alarm 409 alerts the user to press a flashing RED button 410.

For purposes hereof, the initial volume of the audible alarm 409 is referred to as level i=0. The processor 401 checks to see whether RED button 410 has been pressed. If it is not pushed within a preset period as determined by an alarm sub timer, then the volume, i, is incremented by 1. After the volume is incremented, a check is again made as to whether the RED button 410 has been pressed. If, during the process of checking if the RED button 410 has been pressed, the answer is logic 1, YES or TRUE, then the countdown motion timer is reset. If RED button 410 is not pushed by the time the volume has increased to a volume level of i=3 (or other appropriate level), then, inasmuch as the user may be incapacitated or unconscious, a mandatory HELP message is fetched from memory 413 by processor 401 and sent by transceiver 412 over a communications channel to a caregiver, first responder, relative, dispatch center, or the like. The caregiver, first responder, relative, dispatch center, or the like, may then try to call the user over a telephone. If the user answers the telephone such that help is not needed, then RED button 410 can be pushed by the user to reset the timer of countdown motion timer unit 407, or alternatively, the person who called the user in response to receiving the HELP message, may be able to enter a code or tones into their handset, e.g., causing their handset to send certain predetermined DTMF tones which, when received by transceiver 412, cause the timer of countdown motion timer unit 408 to be reset.

Further, device 400 can be adapted to send, by pressing GREEN button 411, a message, e.g., ALL'S WELL. The message is fetched from memory 413 by processor 401 and sent over a communications channel from transceiver 412 to a receiver at which the message is received by, e.g., a relative, responder or dispatch center. The transceiver 412 can utilize any number of communication channels, such as: (1) over a short range wireless link to a base station, that then can access (a) the public telephone network and send the message as a computer generated voice, (b) a wireless network and send the message as (i) a computer generated voice, (ii) and SMS text message, or (iii) a multimedia message; or (2) directly to a wireless telecommunications network, e.g., WiMax, CMDA, GSM, WCDM, 3G, 4G, and send the message as (1) a computer generated voice, (2) and SMS text message, or (3) a multimedia message. When using a short range wireless link, said link can be e.g., a WiFi link, Bluetooth link or the like. The memory 413 stores messages in an appropriate format that can be decoded as text messages, audible messages, multimedia messages, etc., and that are sent to the transceiver 412 to be modulated and sent over the communications channel to a receiver to be received, directly or indirectly, by a caregiver, first responder, relative, dispatch center, or the like.

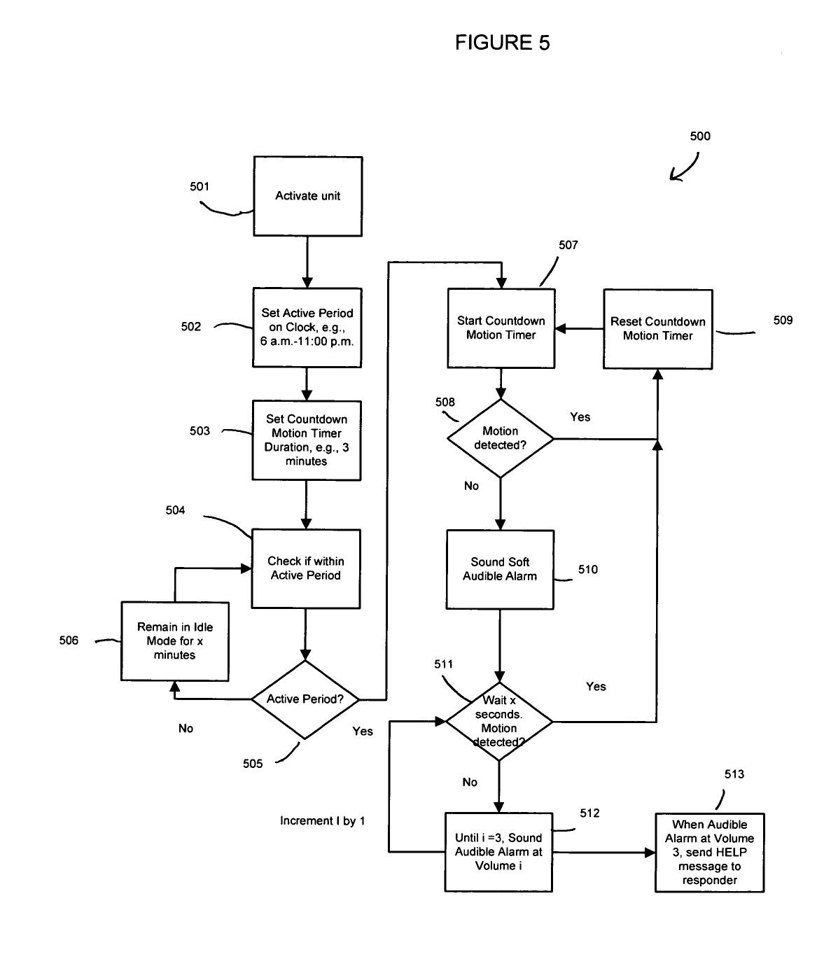

FIG. 5 is a flow chart of the method 500 of the third embodiment of the present invention. The third embodiment of the present invention is adapted to reset a timer having a set duration, e.g., 2 minutes, each time it detects motion. If the motion detector does not detect any motion for more than, e.g., two minutes, then an audible alarm on the device sounds at increasing levels, alerting the user to e.g., shake the device, so that motion is sensed. Once motion is sensed, the countdown motion timer is reset. If motion is not sensed within a by the time the audible alarm is at a predetermined level, e.g., within 60 seconds, then a HELP message is sent to another person, e.g., relative, responder or dispatch center. As seen therein, in step 501, the device of the present invention is activated. In step 502, the period during which the device will be active can be set using, for example, a clock. The device can have a screen, such as an LED or LCD screen, which allows the user to set the active period. In step 503, the duration of a countdown motion timer on the device is set. In steps 504 and 505, a check is made from time to time to determine if the device is within the active period. If not, in step 506 the device remains in idle mode and checks from time to time, whether it has entered active mode. If so, then in step 507, the countdown motion timer started. Each time motion is detected in step 508, the countdown motion timer is reset in step 509. Based on the foregoing, if the timer has elapsed in step 510, then necessarily, no motion has been detected and hence, in step 511, the audible alarm is sounded at an initial threshold level audible to human hearing, the level of which can be set by the user. For purposes hereof, the initial volume is referred to as level i=0. In step 512, an alarm sub timer is initialized to determine how long an alarm at a specific volume is sounded. A check is then made in step 513 of whether motion is detected. If not, in step 514, the alarm sub timer is checked to determine if it has elapsed. If so, then the volume, i, of the alarm is incremented by 1 in step 516. After the volume is incremented, a check is again made as to whether motion is detected in step 513. If, during the process of checking if motion is detected, the answer is logic 1, YES or TRUE, then the countdown motion timer is reset in step 509. If motion is not detected by the time the volume has increased to a volume level of i=3 in step 517, then, inasmuch as the user may be incapacitated or unconscious, in step 518, a mandatory HELP message is sent over the communications channel to a caregiver, first responder, relative, dispatch center, or the like. The caregiver, first responder, relative, dispatch center, or the like, may then try to call the user over a telephone. If the user answers the telephone such that help is not needed, then the device can be reset by shaking it, pressing a button, or alternatively, the person who called the user may be able to enter a code or tones which are received by the unit and cause it to be reset.

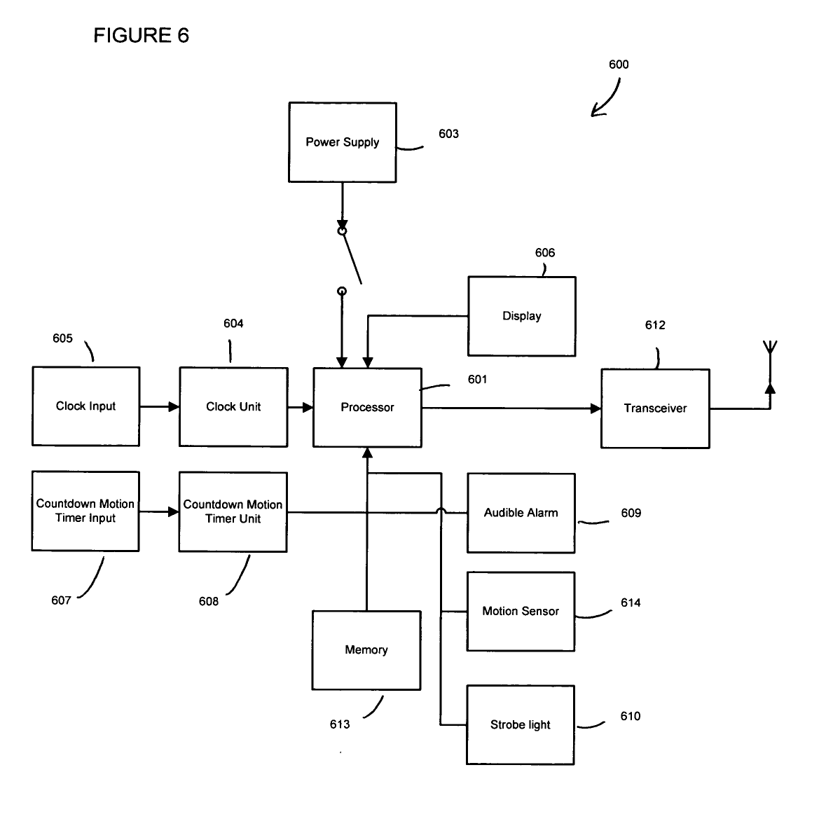

FIG. 6 is a block diagram of the device 600 of a third embodiment of the present invention. As seen therein, the device 600 of the present invention comprises several functional blocks coupled via data busses and adapted to perform the method described in FIG. 5. The processor block 601, being the main functional element, is activated using e.g., an on-off switch 602 coupled to power block 603, which is also adapted to provide regulated power to other parts of the device 600 via a power bus (not shown). The device has a clock unit 604, which is set to the time at the location of the user. Signals, as determined from user input from user input block 605, derived from clock unit 604 can be used to determine when the processor 601 is in its active state.

The device 600 includes as display 606, such as an LED or LCD screen, which allows the user to see what parameters have been set via the various input units. The device further includes a countdown motion timer unit 608 and a countdown motion timer input 607 where the duration of the countdown timer on the device 600 is set. The countdown timer is used to determine whether a certain amount of time has elapsed since the motion sensor 614 has sensed motion.

A check is made from time to time of whether the device 600 is within the active period. If not, the device 600 remains in idle mode and continues to check from time to time, whether it has entered active mode. If it determines it is in active mode, then the countdown motion timer unit 607 is checked from time to time. Each time motion is detected by motion sensor 614, then the timer in countdown motion timer unit 608 is reset, and begins counting down again. Based on the foregoing, if the countdown motion timer elapses, then necessarily, no motion has been detected by motion sensor 614 during the time selected. Once the timer has elapsed then the audible alarm 609 is sounded at an initial, threshold level audible to human hearing, the level of which can be set by the user. In addition, the device can strobe a high intensity bulb 610 to alert the user. The activation of the audible alarm 609 alerts the user to shake the device to reset the countdown motion timer 608.

For purposes hereof, the initial volume of the audible alarm 609 is referred to as level i=0. The processor 601 checks to see whether the motion sensor 614 has sensed or detected motion. If it has not detected motion within a preset period, then the volume, i, is incremented by 1. Countdown motion timer unit is adapted to serve as an alarm sub timer which is initialized to determine how long an alarm at a specific volume is sounded. A check is then made by processor 601 of whether motion is detected. If not, the alarm sub timer is checked to determine if it has elapsed. If so, then the volume, i, of the alarm is incremented by 1. After the volume is incremented, a check is again made as to whether motion sensor 614 has sensed motion. If, during the process of checking if the motion sensor 614 has sensed motion, the answer is logic 1, YES or TRUE, then the countdown motion timer 608 is reset. If motion has not been sensed by motion sensor 614 by the time the volume has increased to a volume level of i=3 (or other appropriate level), then, inasmuch as the user may be incapacitated or unconscious, a mandatory HELP message is fetched from memory 613 by processor 601 and sent by transceiver 612 over a communications channel to a caregiver, first responder, relative, dispatch center, or the like. The caregiver, first responder, relative, dispatch center, or the like, may then try to call the user over a telephone. If the user answers the telephone such that help is not needed, then motion sensor 614 can be activated by shaking the device to reset the timer of countdown motion timer unit 608, or alternatively, the person who called the user in response to receiving the HELP message, may be able to enter a code or tones into their handset, e.g., causing their handset to send certain predetermined DTMF tones which, when received by transceiver 612, cause the timer of countdown motion timer unit 608 to be reset.

The memory 613 stores messages in an appropriate format that can be decoded as text messages, audible messages, multimedia messages, etc., and that are sent to the transceiver 612 to be modulated and sent over the communications channel to a receiver to be received by a caregiver, first responder, relative, dispatch center, or the like.

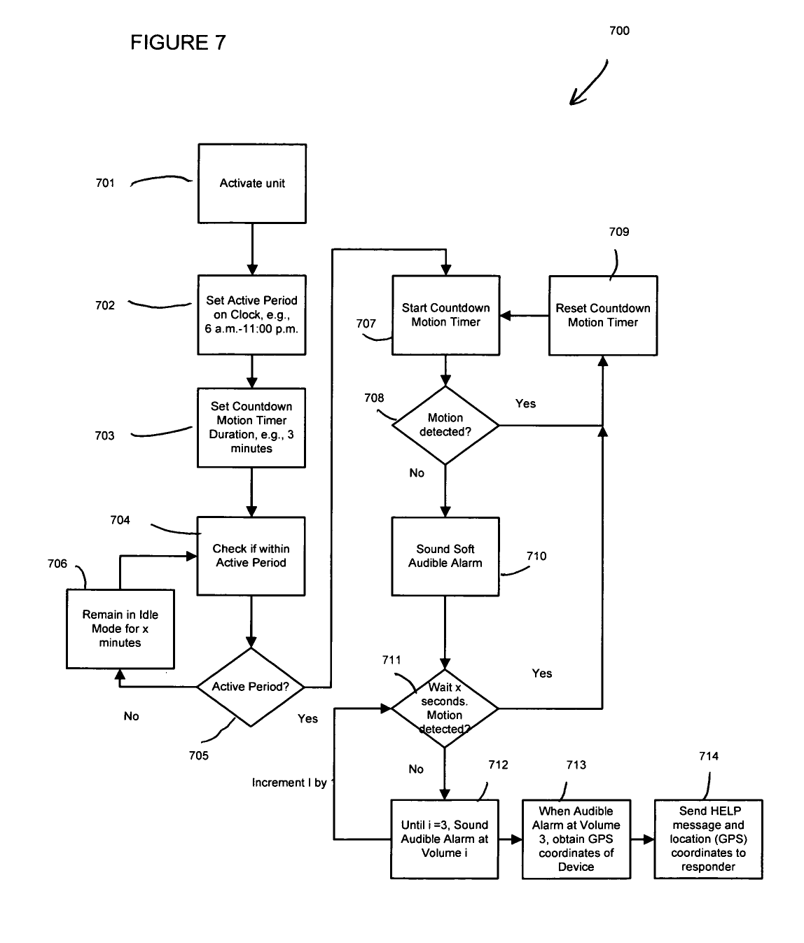

FIG. 7 is a flow chart of the method 700 of the fourth embodiment of the present invention. The fourth embodiment of the present invention is adapted to reset a timer having a set duration each time it detects motion. If the motion detector does not detect any motion for more than the preset time, then an audible alarm on the device sounds, alerting the user to e.g., shake the device, so that motion is sensed. Once motion is sensed, the countdown motion timer is reset. If motion is not sensed within a second time period, e.g., 30 seconds, then a HELP message is sent to another person, e.g., relative, responder or dispatch center, along with location coordinates, such as global positioning satellite (GPS) coordinates. As seen therein, in step 701, the device of the present invention is activated. In step 702, the period during which the device will be active can be set using, for example, a clock. The device can have a screen, such as an LED or LCD screen, which allows the user to set the active period. In step 703, the duration of a countdown motion timer on the device is set. In steps 704 and 705, a check is made from time to time to determine if the device is within the active period. If not, in step 706 the device remains in idle mode and checks from time to time, whether it has entered active mode. If so, then in steps 707, the countdown motion timer started. Each time motion is detected in step 708, the countdown motion timer is reset in step 709. Based on the foregoing, if the timer has elapsed in step 710, then necessarily, no motion has been detected and hence, in step 711, the audible alarm is sounded at an initial threshold level audible to human hearing, the level of which can be set by the user. For purposes hereof, the initial volume is referred to as level i=0. In step 712, an alarm sub timer is initialized to determine how long an alarm at a specific volume is sounded. A check is then made in step 713 of whether motion is detected. If not, in step 714, the alarm sub timer is checked to determine if it has elapsed. If so, the volume, i, is incremented by 1. After the volume is incremented, a check is again made as to whether motion is detected in step 713. If, during the process of checking if motion is detected, the answer is logic 1, YES or TRUE, then the countdown motion timer is reset in step 709. If motion is not detected by the time the volume has increased to a volume level of i=3 in step 716, then, inasmuch as the user may be incapacitated or unconscious, in step 718, the device obtains GPS coordinates and in step 719, a mandatory HELP message is sent over at least one communications channel to a caregiver, first responder, relative, dispatch center, or the like. The caregiver, first responder, relative, dispatch center, or the like, may then try to call the user over a telephone. If the user answers the telephone such that help is not needed, then the device can be reset by shaking it, pressing a button, or alternatively, the person who called the user may be able to enter a code or tones which are received by the unit and cause it to be reset.

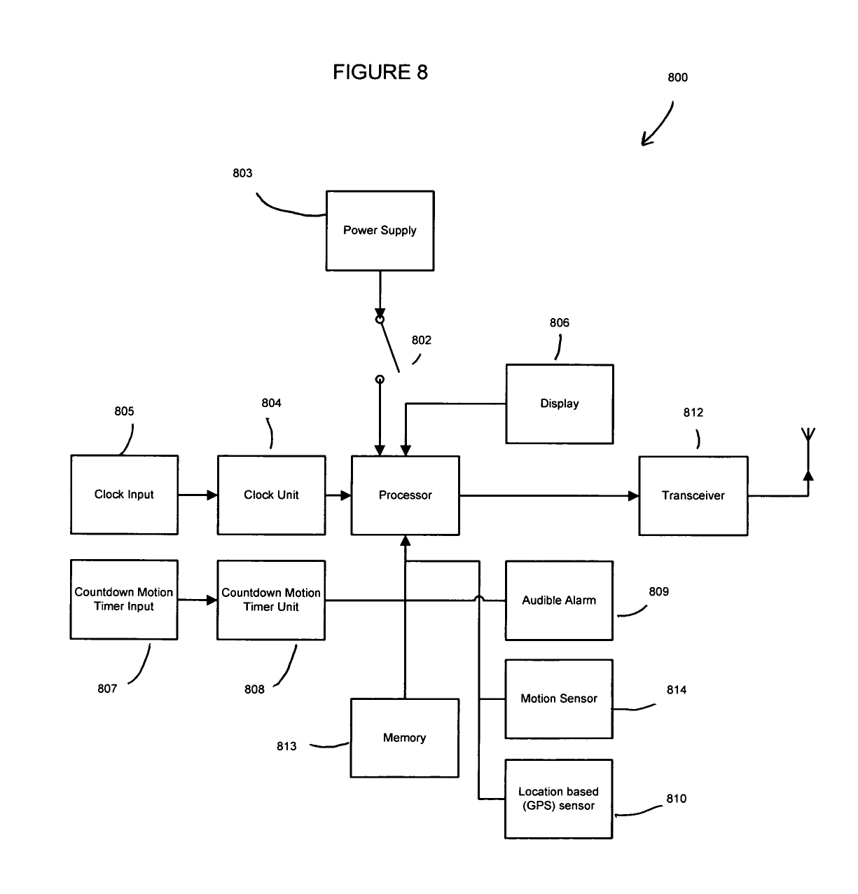

FIG. 8 is a block diagram of the device 800 of the fourth embodiment of the present invention. As seen therein, the device 800 of the present invention comprises several functional blocks coupled via data busses and adapted to perform the method described in FIG. 7. The processor block 801, being the main functional element, is activated using e.g., an on-off switch 802 coupled to power block 803, which is also adapted to provide regulated power to other parts of the device 800 via a power bus (not shown). The device has a clock unit 804, which is set to the time at the location of the user. Signals, as determined from user input from user input block 805, derived from clock unit 804 can be used to determine when the processor 801 is in its active state.

The device 800 includes as display 806, such as an LED or LCD screen, which allows the user to see what parameters have been set via the various input units. The device further includes a countdown motion timer unit 808 and a countdown motion timer input 807 where the duration of the countdown timer on the device 800 is set. The countdown timer is used to determine whether a certain amount of time has elapsed since the motion sensor 814 has sensed motion.

A check is made from time to time of whether the device 800 is within the active period. If not, the device 800 remains in idle mode and continues to check from time to time, whether it has entered active mode. If it determines it is in active mode, then the countdown motion timer unit 807 is checked from time to time. Each time motion is detected by motion sensor 814, then the timer in countdown motion timer unit 808 is reset, and begins counting down again. Based on the foregoing, if the countdown motion timer 808 elapses, then necessarily, no motion has been detected by motion sensor 814 during the time selected. Once the timer has elapsed then the audible alarm 809 is sounded at an initial, threshold level audible to human hearing, the level of which can be set by the user. In addition, the device can strobe a high intensity strobe (not shown) to alert the user. The activation of the audible alarm 809 alerts the user to shake the device to reset the countdown motion timer 808.

For purposes hereof, the initial volume of the audible alarm 809 is referred to as level i=0. Countdown motion timer unit 808 is adapted to serve as an alarm sub timer which is initialized to determine how long an alarm at a specific volume is sounded. A check is then made by processor 801 of whether motion sensor 814 has detected motion. If not, the alarm sub timer is checked to determine if it has elapsed. If so, then the volume, i, is incremented by 1. After the volume is incremented, a check is again made as to whether motion sensor 814 has sensed motion. If, during the process of checking if the motion sensor 814 has sensed motion, the answer is logic 1, YES or TRUE, then the countdown motion timer 808 is reset. If motion has not been sensed by motion sensor 814 by the time the volume has increased to a volume level of i=3 (or other appropriate level), then, inasmuch as the user may be incapacitated or unconscious, location based sensor 810 obtains location coordinates, e.g., via a GPS receiver, and is coupled with a mandatory HELP message that is fetched from memory 813 by processor 801 and sent by transceiver 812 over a communications channel to a caregiver, first responder, relative, dispatch center, or the like. The caregiver, first responder, relative, dispatch center, or the like can then locate the user using a GPS device. For example, the transceiver 812 can send the GPS coordinates and HELP message to a GPS enabled wireless device in order try to expedite help to the user. The memory 813 stores messages in an appropriate format that can be decoded as text messages, audible messages, multimedia messages, etc., and that are sent to the transceiver 812 to be modulated and sent over the communications channel to a receiver to be received by a caregiver, first responder, relative, dispatch center, or the like.

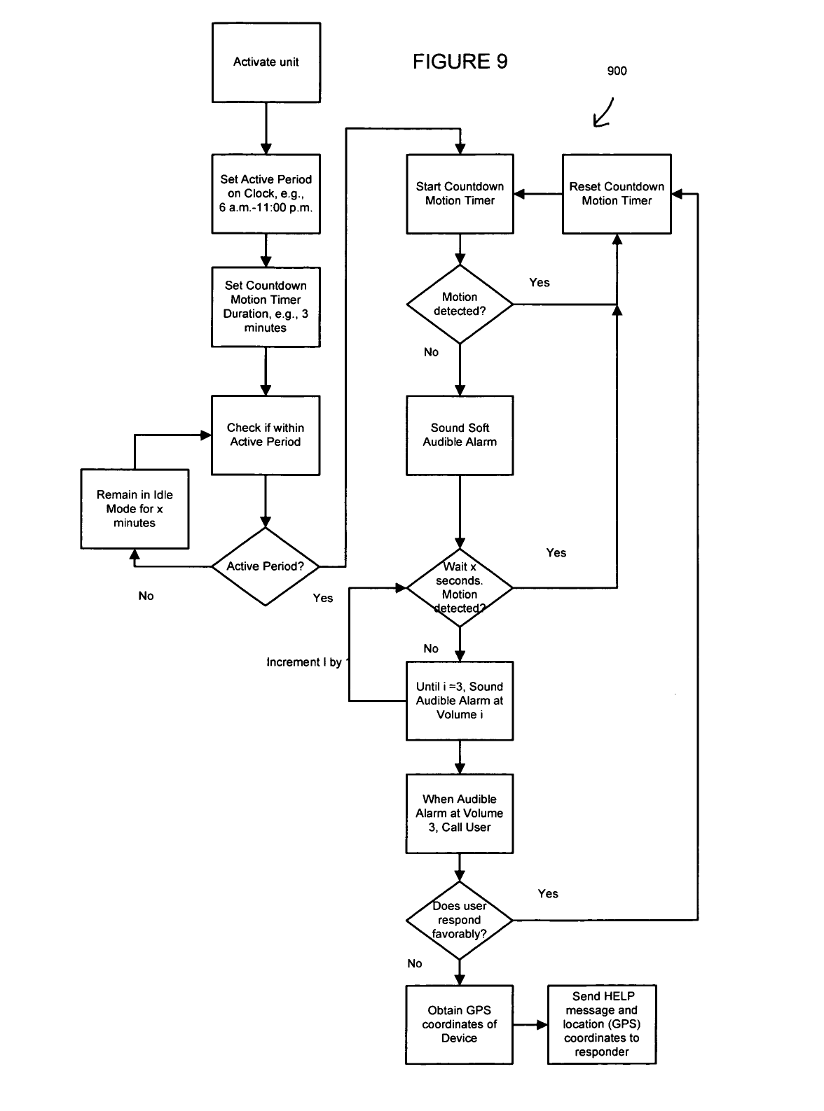

FIG. 9 is a flow chart of the method 900 of a fifth embodiment of the present invention. As seen therein, the method is similar to that of the fourth embodiment, however, an attempt is made to contact the user prior to sending GPS data from the user to a caregiver, first responder, relative, dispatch center, or the like.

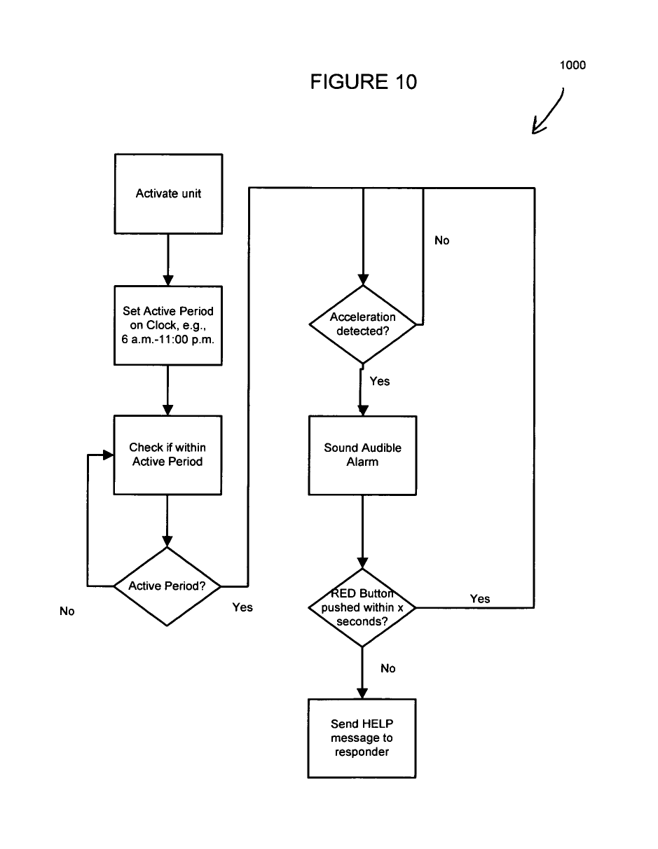

FIG. 10 is a flow chart of the method 1000 of a sixth embodiment of the present invention. As seen therein, instead of the lack of motion triggering a call to a caregiver, first responder, relative, dispatch center, or the like, a rapid acceleration (such as might be experienced by a fall or an epileptic episode), serves to sound an alarm. If a RED button is not pushed within a certain time, then the alert is sent to a caregiver, first responder, relative, dispatch center, or the like. The processor used to implement the sixth embodiment can further combine signals from a motion sensor and accelerometer to determine when to trigger an alarm and communication. For example, if a rapid acceleration is detected with, thereafter a period of motion below a certain threshold, then the device may be programmed to sound the alarm and send out a HELP message.

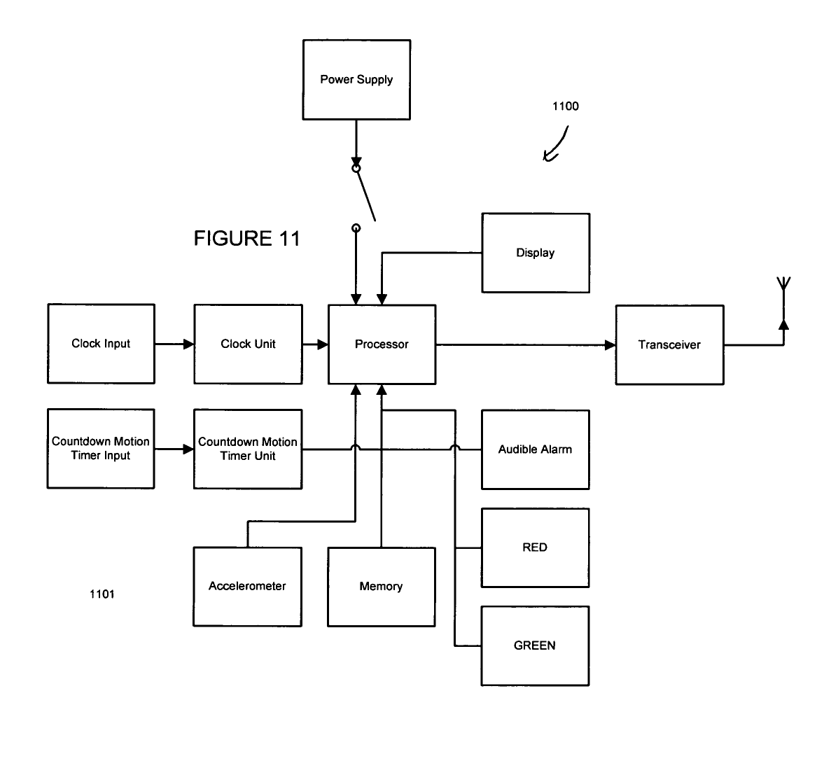

FIG. 11 is a block diagram of the device 1100 of a sixth embodiment of the present invention. As seen therein, accelerometer 1101 takes the place of a motion sensor. As noted above, a motion sensor (not shown) may be coupled with the accelerometer in this embodiment.

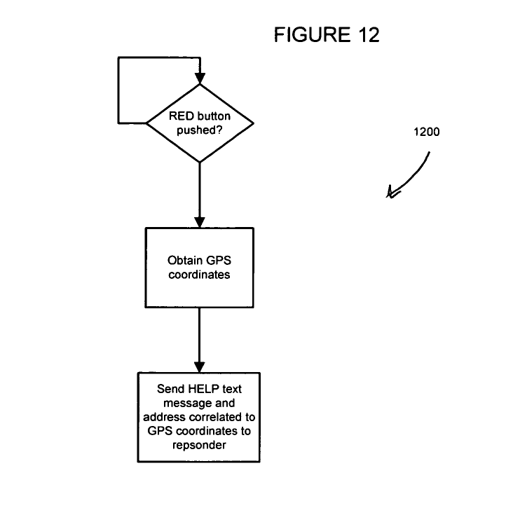

FIG. 12 is a flow chart of the method 1200 of a seventh embodiment of the present invention. As seen therein, if a RED button is pushed, the device is adapted to obtain GPS coordinates and send them to a caregiver, first responder, relative, dispatch center, or the like.

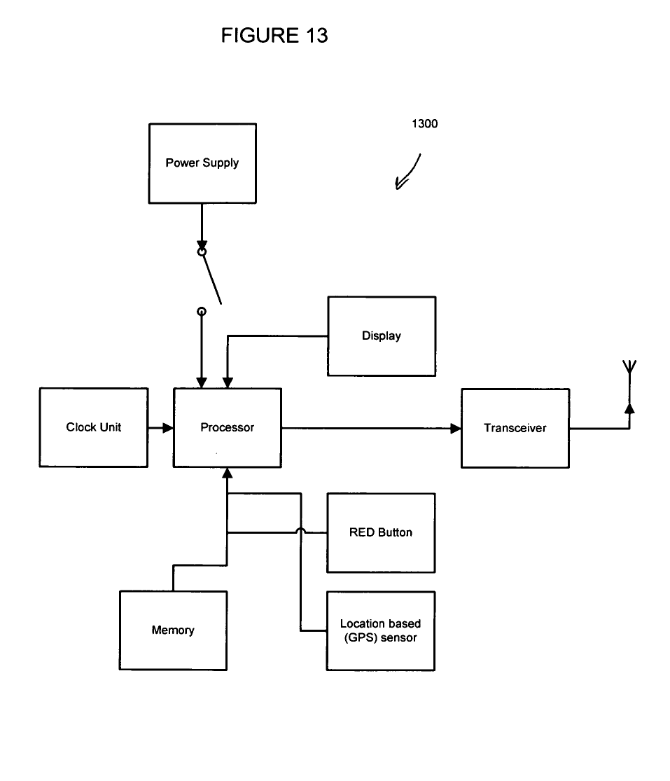

FIG. 13 is a block diagram of the device 1300 of a seventh embodiment of the present invention.

As seen herein, the present invention comprises a method and system adapted to alert others that a user is in need of help, when the user is incapacitated or unconscious. Such methods and devices use at least one sensor, one clock, one timer, one audible alarm, at least one button with multiple functionality or several buttons each having a specific functionality, and a transmitter adapted to send health and welfare data across at least one communication channel to a receiver. The device of the present invention can use motion or acceleration sensors and/or timer activated switches coupled to to wireless and location based, such as global positioning satellite (GPS) systems. A variety of sensors can be used alone or in combination to decide if the user is in need of help, including temperature sensors and other physiological sensors that measure respiration, galvanic skin response, blood volume pulse, electromyogram, heart rate, etc. and general somatic activity and environmental sensors.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

We claim:

1. A method for alerting others of the health and welfare of a person, comprising:
setting a timer in a device worn by a person;
resetting the timer if motion is detected;
if the timer elapses, sounding an audible alarm;
if the timer is not reset, sending a predetermined message over a communication channel to a receiver.

2. The method of claim 1, further comprising using a location based system in the device to send the location of the person in the message over the communication channel to the receiver.

3. The method of claim 1, further comprising the steps of detecting an acceleration over a predetermined threshhold and sending a predetermined message over a communication channel to a receiver.

4. The method of claim 1, wherein the device is in the form factor of a pendant.

5. The method of claim 1, wherein the device is in the form factor of a watch.

6. The method of claim 1, wherein the device is in the form factor of a module having a belt clip attachment.

7. A device adapted to be worn by a person for alerting others of the health and welfare of the person, comprising:
a processor having a memory;
a timer coupled to the processor;
a motion sensor coupled to the processor and adapted to cause the processor to reset the timer if motion is detected; and
an audible alarm coupled to the processor adapted to sound if the timer elapses.

8. The device of claim 7, further comprising a switch adapted to manually reset the timer.

9. The device of claim 8, further comprising a transceiver coupled to the processor, the processor adapted to fetch a message from the memory and cause the message to be sent by the transceiver if the button is not depressed to reset the timer within a predetermined time limit.

10. The device of claim 7, further comprising a transceiver coupled to the processor, the processor adapted to fetch a message from the memory and cause the message to be sent by the transceiver if the button is not depressed to reset the timer within a predetermined time limit.

11. The device of claim 10, further comprising a location based system in the device coupled to the transceiver and adapted to send the location of the person in the message over the communication channel to a receiver.

12. The device of claim 11, in combination with a receiver adapted to receive the message.

13. The device of claim 7, wherein the device is in the form factor of a watch.

14. The device of claim 7, wherein the device is in the form factor of a pendant

15. The device of claim 7, wherein the device is in the form factor of a module having a belt clip attachment.

16-20. (canceled)
